(19) United States
(12) Patent Application Publication
(10) Pub. No.: US 2026/0092708 A1
(43) Pub. Date: Apr. 2, 2026

(54) ELECTRIC FIREPLACE WITH EXTRA-LOW-VOLTAGE HEATING ELEMENTS

(71) Applicant: HNI Technologies Inc., Muscatine, IA (US)

(72) Inventors: Jake Clifton, Lakeville, MN (US); Tommie Kelley, Lakeville, MN (US); Moffat Omuya, Lakeville, MN (US); Corey Radloff, Lakeville, MN (US); Erika Saffer, Lakeville, MN (US)

(21) Appl. No.: 19/343,643

(22) Filed: Sep. 29, 2025

Related U.S. Application Data
(60) Provisional application No. 63/700,410, filed on Sep. 27, 2024.

(51) Int. Cl. F24C 7/00; F21S 10/04; F24C 7/06; F24C 7/08

(52) U.S. Cl. CPC F24C 7/004; F21S 10/04; F24C 7/062; F24C 7/08

(57) ABSTRACT

An electric fireplace includes a plurality of extra-low-voltage (ELV) heating elements and a universal power supply. The plurality of extra-low-voltage (ELV) heating elements operate at less than 50V of alternating current (VAC) or 120V of direct current (VDC) and are disposed on at least one portion of the electric fireplace. The universal power supply is operatively coupled with the plurality of ELV heating elements. The universal power supply operates to receive, convert, and step down an alternating current (AC) power source to provide power for the plurality of ELV heating elements.

### CROSS REFERENCE TO RELATED APPLICATION

This application claims the benefit of U.S. App. No. 63/700,410, filed Sep. 27, 2024, the disclosure of which is incorporated herein by reference in its entirety for all purposes.

### FIELD

The present disclosure relates generally to fireplaces, and more specifically to electric fireplaces.

### BACKGROUND

Conventional electric fireplaces utilize electric heaters that are powered using alternating current (AC), such as those that receive electricity from the power grid in order to provide sufficient amount of heat output. For example, electric heaters that are used in such electric fireplaces are generally low-voltage heaters using 50V of alternating current (VAC) to 1000 VAC of electricity, more typically 120 VAC or 240 VAC in consumer-based products in North America. In order for the product to be paired with the local utility power (or power grid) with different configurations required for different regions around the world, there is a need for the product to accommodate for the different voltages and frequencies that may apply.

### SUMMARY

According to an example (“Example 1”), an electric fireplace includes: a plurality of extra-low-voltage (ELV) heating elements each operating at less than 50V of alternating current (VAC) or 120V of direct current (VDC) to generate heat for the electric fireplace; and a universal power supply operatively coupled with the plurality of ELV heating elements, wherein the universal power supply operates to receive, convert, and step down an alternating current (AC) power source to provide power for the plurality of ELV heating elements.

According to another example (“Example 2”) further to Example 1, the universal power supply is located in a low voltage region of the electric fireplace, and the ELV heating elements are located in an ELV region of the electric fireplace. The ELV region defines at least 80% of a visible or tangible surface of the electric fireplace.

According to another example (“Example 3”) further to Example 1 or 2, the universal power supply is located external to the ELV heating elements and is coupled to the ELV heating elements via an electrical connector.

According to another example (“Example 4”) further to Example 3, the ELV heating elements are disposed in a high-risk location for electric shock, and the universal power supply is disposed in a low-risk location for electric shock.

According to another example (“Example 5”) further to Example 4, the high-risk location and the low-risk location are in separate rooms of a building or in separate buildings from each other.

According to another example (“Example 6”) further to any preceding Example, the electric fireplace includes at least one low-voltage component and a plurality of ELV components. The universal power supply is one of the at least one low-voltage component, and the ELV components include the ELV heating elements that are located downstream of the at least one low-voltage component.

According to another example (“Example 7”) further to Example 6, the ELV components include a power distribution device operative to distribute power to the ELV components downstream of the fuse board and to provide overcurrent protection using a means of breaking a circuit.

According to another example (“Example 8”) further to Example 6, the ELV components include a relay board operative to provide isolation of other ELV components from the ELV heating elements.

According to another example (“Example 9”) further to Example 6, the ELV components include one or more of the following: one or more heating control features; one or more speakers; one or more visual fire features; one or more lighting features; and a controller configured to control operation of the heating control features, the speakers, the visual fire features, the lighting features, and/or the ELV heating elements.

According to another example (“Example 10”) further to any preceding Example, the electric fireplace includes a plurality of additional ELV components such that all electric components of the electric fireplace operate at less than 50 VAC or 120 VDC.

According to another example (“Example 11”) further to any preceding Example, the ELV heating elements are disposed in two columns on the at least one portion of the electric fireplace.

According to another example (“Example 12”) further to any preceding Example, the ELV heating elements are disposed in two rows on the at least one portion of the electric fireplace.

According to another example (“Example 13”) further to any preceding Example, the electric fireplace includes a display monitor disposed on the at least one portion of the electric fireplace. The ELV heating elements are disposed to surround the display monitor on all four sides.

According to another example (“Example 14”) further to any preceding Example, the at least one portion of the electric fireplace includes two or more of: a front portion, a top portion, at least one of two side portions, or a back portion of the electric fireplace.

According to another example (“Example 15”) further to any preceding Example, the electric fireplace includes at least one adjustable louver for the discharge of the heating element for directional changes along an x-axis, an y-axis, or a combination thereof.

According to another example (“Example 16”) further to any preceding Example, the universal power supply comprises a plurality of individually operable power supply units connected in a parallel configuration.

According to another example (“Example 17”) further to any preceding Example, the universal power supply includes one or more batteries.

According to an example (“Example 18”), an electric fireplace includes: a housing comprising one or more linear actuators; a plurality of extra-low-voltage (ELV) heating elements each operating at less than 50V of alternating current (VAC) or 120V of direct current (VDC) to generate heat for the electric fireplace; and a universal power supply operatively coupled with the plurality of ELV heating elements, wherein the universal power supply operates to receive, convert, and step down an alternating current (AC) power source to provide power for the plurality of ELV heating elements.

The linear actuators are configured to adjust positions of the ELV heating elements in one or more directions with respect to the housing.

According to another example (“Example 19”) further to Example 18, the one or more directions includes one or more of: a direction along an x-axis, a direction along a y-axis, a combination of the x-axis and the y-axis, or a z-axis.

According to another example (“Example 20”) further to Example 18 or 19, the one or more linear actuators are ELV-compatible.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 (prior art) illustrates a block diagram of a conventional electric fireplace system with an AC heating element as known in the art.

FIG. 2 illustrates a block diagram of an electric fireplace system with DC heating elements and a universal power supply, according to aspects of the present disclosure.

FIG. 3 illustrates a front view of an electric fireplace with ELV and low voltage regions, according to aspects of the present disclosure.

FIG. 4 illustrates a block diagram of an electric fireplace system with components in separate locations, according to aspects of the present disclosure.

FIG. 5 illustrates a block diagram of an electric fireplace system with power distribution components, according to aspects of the present disclosure.

FIG. 6A illustrates a front portion of a fireplace with ELV heating elements in two columns, according to aspects of the present disclosure.

FIG. 6B illustrates a front portion of a fireplace with ELV heating elements in two rows, according to aspects of the present disclosure.

FIG. 6C illustrates a front view of an electric fireplace with ELV heating elements surrounding a display, according to aspects of the present disclosure.

FIG. 6D illustrates a perspective view of an electric fireplace with ELV heating elements surrounding multiple different surfaces of the housing, according to aspects of the present disclosure.

FIG. 7 illustrates a configuration of power supply units in a parallel arrangement, according to aspects of the present disclosure.

### DETAILED DESCRIPTION

The present disclosure is generally directed to a fireplace or fireplace system which includes a plurality of extra-low-voltage (ELV) heating elements each operating at less than 50V of alternating current (VAC) or 120V of direct current (VDC) to generate heat for the fireplace or fireplace system, and a universal power supply operatively coupled with the plurality of ELV heating elements. The universal power supply operates to receive, convert, and step down an alternating current (AC) power source to provide power for the plurality of ELV heating elements While receiving more voltage can generate more heat at lower current draws, such as electric fireplaces operable in 220V/12.27 A or 240V/11.25 A to produce up to 2700 W or up to 10,000 BTUs (British thermal units), doing so generally comes with a risk of possible electrical shock when users touch parts of the electric fireplace (for example, anywhere on the front-facing side of the fireplace that faces the users) during operation due to the potential of 120/240 VAC relative to the resistance of the human body. It is generally understood that high voltage fireplaces, such as greater than 1000 VAC or greater than 1500V of direct current (VDC), have the risk of electrical arcing, but low voltage fireplaces (from 50VAC to 1000 VAC or from 120 VDC to 1500 VDC) still have the risk of electrical shock for users who may come in contact with the fireplace.

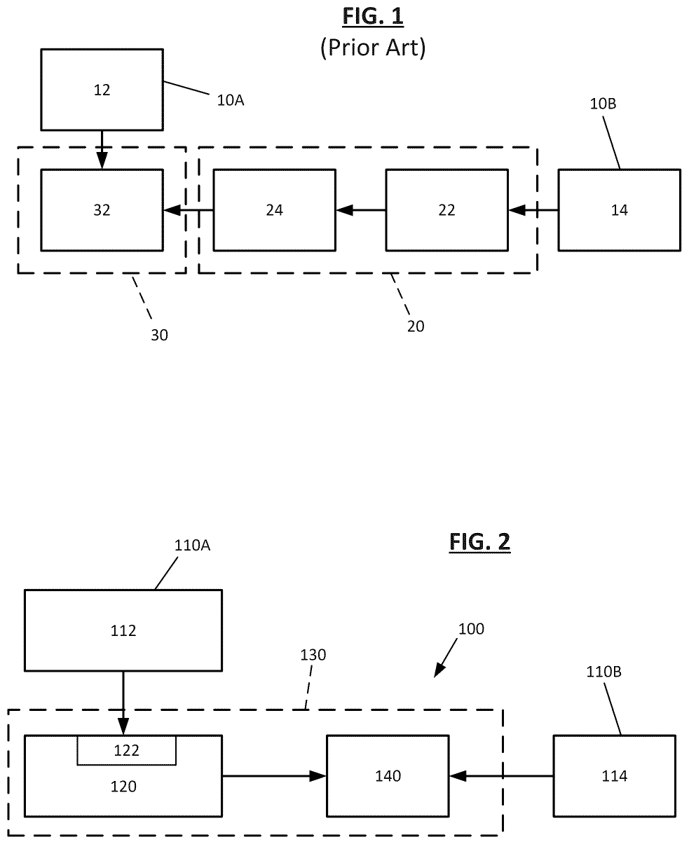

Additionally, having to accommodate for the different configurations in different regions can add to the cost of the product and increases complexity of the product (both for manufacturing and stocking of the products). As an illustrative example, FIG. 1 shows an electric fireplace that includes an AC-powered heating element 32 as one of its components, as known in the art. The AC-powered heating element 32 may be a 120 VAC heating element, for example, that can be connected to a first power source 10A and a second power source 10B. The first power source 10A may be an AC power source 12 such as the power grid, providing electricity in the range of, for example, 80 to 260 VAC (volts alternating current) in 50 to 60 Hz frequency. The second power source 10B may be a direct current (DC) power source 14 such as a battery.

However, in order for the AC heating element 32 to receive power from the DC power source 14, the DC power source 14 must be coupled with a DC/AC inverter 22 to convert DC power into AC power, after which the voltage of the AC power must be increased using a step-up transformer 24 (after conversion to AC using an inverter), since the DC power source 14 is likely operating at a voltage level that is lower than the voltage level of the AC heating element 32. In this regard, users must purchase or additionally prepare such inverter and transformer, which the manufacturer may offer as part of an additional adapter, thus further adding to the cost (either to the user or to the manufacturer) or complexity of the product. Therefore, users will likely only use the AC power source 12 for the fireplace, and the fireplace loses adaptability with regards to its power source.

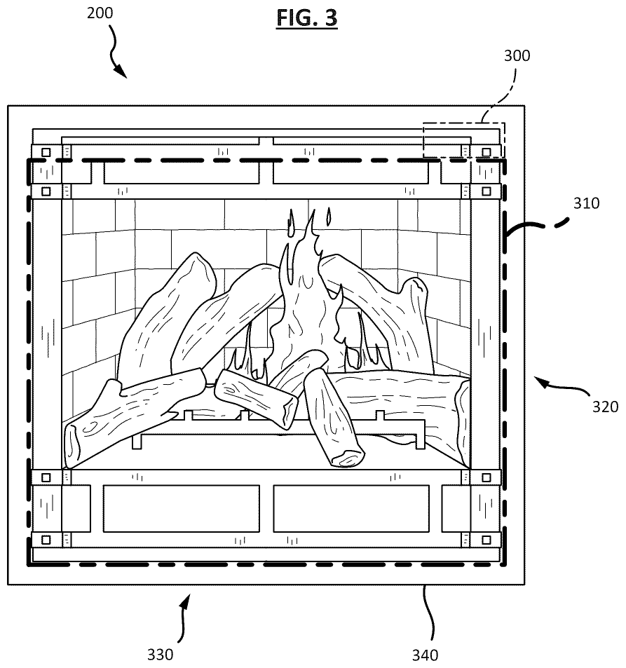

FIG. 2 shows an electric fireplace 100 according to embodiments disclosed herein. For example, the electric fireplace 100 includes a plurality of fireplace electronics implemented therein. The electronics include one or more DC-powered heating elements 140 and a universal power supply 120, both of which are incorporated in the fireplace 100. A heating element may include, for example, a heat generating component such as an electrical resistance component that converts electrical energy into thermal energy so as to generate heat for the electric fireplace 100, and in some cases may also include an electronic component such as an output control device that controls how much thermal energy may be generated. In some examples, the heating element may be contained in a housing or disposed on a support component that supports the components of the heating element to allow the heating element to be placed in a desired location with respect to the electric fireplace 100. In some examples, the DC-powered heating elements 140 and the universal power supply 120 may be disposed within a common housing or integrated together as sold with the fireplace 100, for an adaptive design. In some examples, the DC-powered heating elements 140 and the universal power supply 120 may be disposed in different housings or containers while still operably coupled with each other. The universal power supply 120 provides the functionality of a step-down transformer and an AC/DC converter. The fireplace 100 is directly couplable or connectable with one or more power sources 110, such as a first power source 110A and/or a second power source 110B (either alternatively or simultaneously), where the first power source 110A is an AC power source 112 such as the power grid, and the second power source 110B is a DC power source 114 such as a battery (or batteries) or solar energy, for example. The universal power supply 120 may be incorporated as a preinstalled adapter or a feature that is implemented with the fireplace 100. In some examples, the fireplace 100 may be self-reliant in that the battery or batteries are operable when the fireplace is taken off the power grid, such as during a power outage, and the battery or batteries may be self-charging such as by storing electrical energy that is converted from solar energy (e.g., via photovoltaics), thermal energy (e.g., via thermoelectric generators), chemical energy (e.g., via electrochemical reactions), and/or mechanical energy (e.g., via electromagnetic induction).

The AC power source 112 may have, for example, from 85 to 132 VAC at a frequency of 50 or 60 Hz, or from 170 to 264 VAC at a frequency of 50 or 60 Hz. The universal power supply 120 may include at least one AC input port 122 that accommodates for the voltage supplied by the AC power source 112, such as a selectable switch that selects which type of AC input to receive (such as switching between the 85 to 132 VAC power source and the 170 to 264 VAC power source, for example). The universal power supply 120 may have a working temperature from −30 to 70 degrees Celsius. In some examples, the universal power supply meets the safety standard UL 62368-1, as well as IEC (International Electrotechnical Commission) and EN (European Norm) standards such as IEC/EN61558-1,-2-16; IEC/EN60335-1; EN55022; EN55014, etc. The universal power supply 120 in some examples may withstand up to 300 VAC surge input for up to 5 minutes. The universal power supply 120 may be high-efficiency (or low-loss) component with small load power consumption, such as less than 0.5 W. For example, such design or configuration may allow the fireplace 100 to meet the same certification (or safety standards) as the power supply (e.g. the power source 110), or for the fireplace 100 and the power supply to meet two or more certifications or safety standards including but not limited to those as described above.

Referring back to FIG. 1, a conventional AC heating element 32 can operate in a low-voltage range, which is defined as from 50 VAC to 1000 VAC, typically at 120 VAC/240 VAC, where the voltage is defined as the AC root mean square (RMS) voltage. The tolerance of low-voltage setting can fluctuate by up to ±5%; using 120V as the nominal voltage (in which case the nominal heat output is 1500 W), the input voltage may range from 114V (in which case the heat output is 1354 W) to 126V (in which case the heat output is 1654 W).

Referring to FIG. 2, for example, the universal power supply 120 is capable of regulating the input voltage such that the electrical power provided to each of the DC heating elements 140 is regulated at a voltage level lower than the low-voltage setting, or at an extra-low-voltage (ELV) range, which is defined as a voltage range of less than 50V of alternating current (VAC) or less than 120 V of direct current (VDC). In some examples, the electrical power provided to each DC heating element 140 may be 48V or less, 36V or less, 24V or less, 12V or less, or any other suitable value within the range.

Electrical power may be provided via the universal power supply 120 from the first power source 110A or from the second power source 110B that is the DC power source 114. In both cases, the fireplace electronics can be directly coupled (e.g., electrically connected directly, where “directly” may be defined as being electrically connected or coupled without the use of any additional adaptor or inverter/transformers that are not an integral part of the fireplace) to the power source 110 to receive electrical power therefrom. For example, when regulated at 12V, the heat output may stay consistent (for example, at 1500 W) by increasing the amount of electrical current, because power is the product of voltage and current (P=IV). The DC heating element 140 may be a resistive heating element, and if the resistive heating element has a 9.6-ohm element operating at the nominal voltage of 120V, the electric current may be 12.5 amperes (using V=IR or I=V/R for calculation) for the power output to reach 1500W. The regulated 12V may also have some tolerance, but the tolerance would be consistent across input voltage ranges, whether the input voltage is 114V, 120V, or 126V as mentioned above with respect to the conventional example of FIG. 1. In some examples, there is an adjustment potential for fine-tuning of the output.

In some examples, the DC heating elements 140 may be referred to as ELV heating elements that operate in the ELV region. In some examples, the ELV heating elements may be operating at or below 120V of direct current (VDC) and disposed on at least one portion of the housing, and the universal power supply 120 may be operatively coupled with the plurality of ELV heating elements, and the universal power supply operates to receive, convert, and step down an alternating current (AC) power source to provide power for the plurality of ELV heating elements.

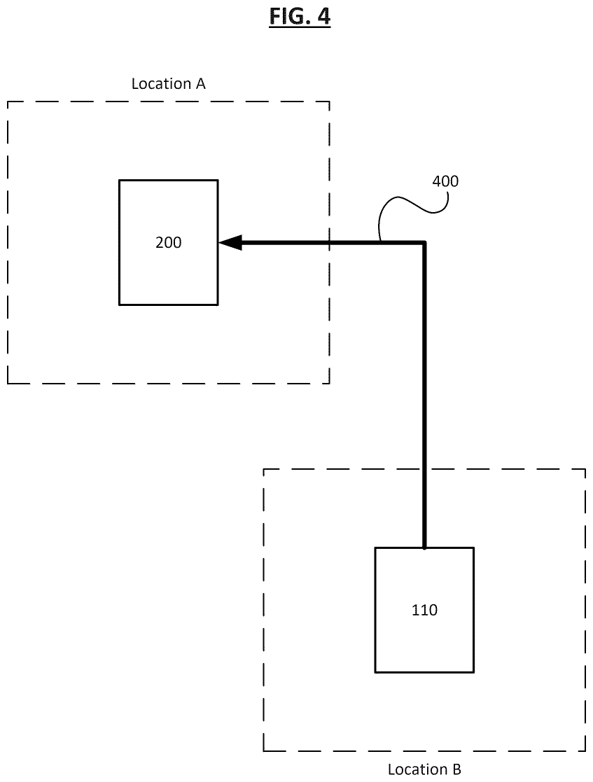

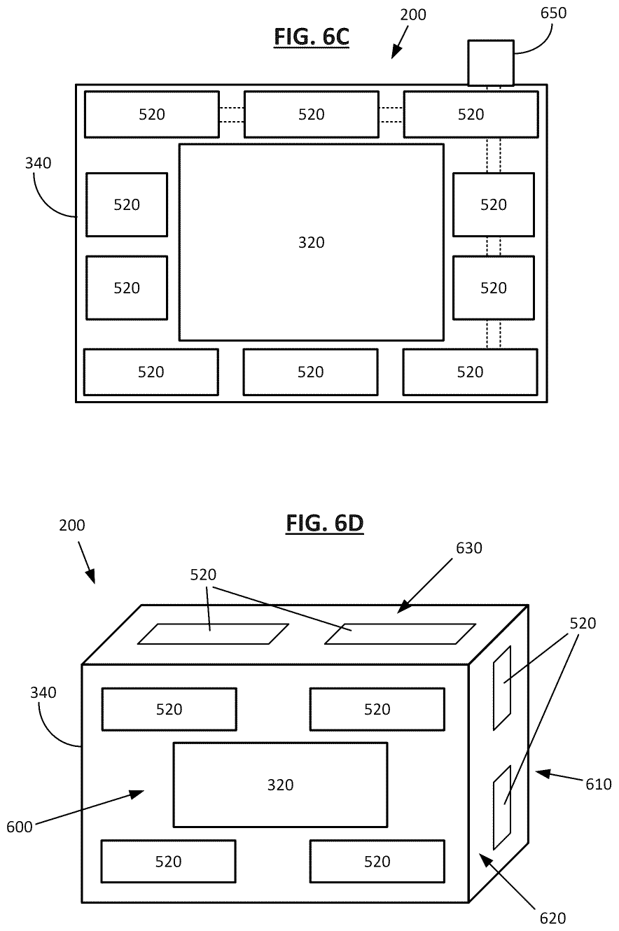

FIG. 3 shows an example of an electric fireplace 200 which may include a low-voltage region 300 and an ELV region 310 in the front-facing portion (e.g., a front portion 600 referred to in FIGS. 6A through 6D), or the front portion of the fireplace that is facing the users (e.g., a visible or tangible surface 330). The low-voltage region 300 may be the region where low-voltage components may be implemented in or disposed on a housing 340 of the fireplace 200, such as a connection port/socket for a power supply or a power switch. The ELV region 310 covers a larger majority of the visible or tangible surface of the fireplace 200, which reduces the potential for electrical shock to the end users. The ELV region 310 may cover or define at least 80%, 90%, or 95% (or any other range therebetween) of the entire visible or tangible surface 330, while the low-voltage region 300 may cover or define no greater than 20%, 10%, or 5% (or any other range therebetween) of the surface 330.

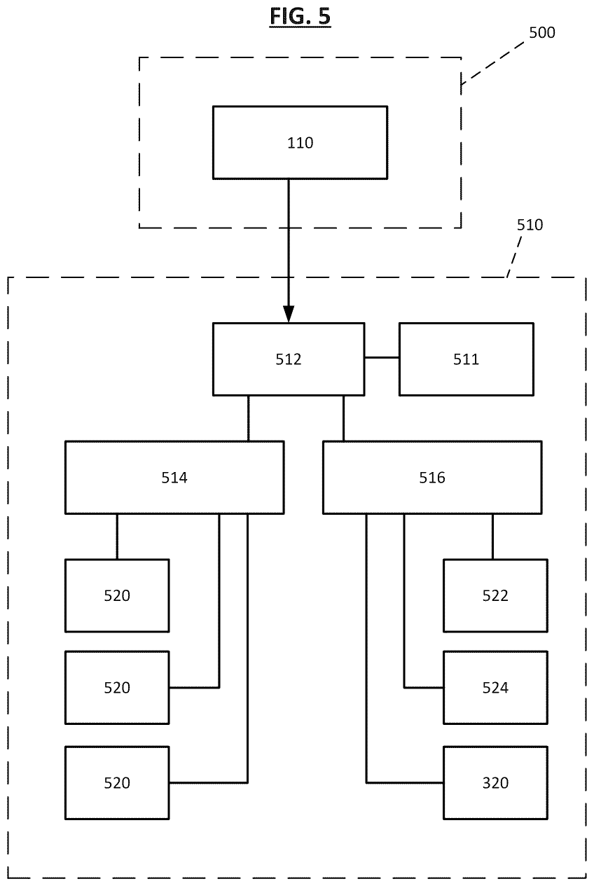

FIG. 4 shows an example of an external power source 110 (such as a low-voltage power source) which may be located at a second location (location B) that is different from a first location (location A) where the ELV fireplace 200 is located. As such, the external power source 110 is located external to the housing of the ELV fireplace 200 and is coupled to the ELV heating elements of the ELV fireplace 200 via an electrical connector 400. The low-voltage power source 110 and the ELV fireplace 200 are connected using the electrical connector 400 such as an insulated power cord. The two locations may be remote or separated from each other (e.g., by one or more walls, or in separate enclosures/buildings) at a suitable distance (e.g., more than 10 m, 100 m, 500 m, or 1 km apart) for safety. For example, location A may be a high-risk or hazardous environment for potential electric shock to the end users, while location B may be a low-risk or safe environment for the end users. As such, the external power source 110 may operate in the safer location B while providing electrical power to the ELV fireplace in the high-risk location A, while still reducing the risk of electric shock at the high-risk location A, since the power source 110 is not present at the high-risk location A. The embodiment shown in FIG. 4 completely removes the low-voltage component from the fireplace (at location A), thus making the fireplace itself entirely ELV, with no low-voltage region on the visible or tangible surface. Therefore, the entirety (that is, 100%) of the visible or tangible surface 330 of the ELV fireplace 200 would be considered the ELV region 310.

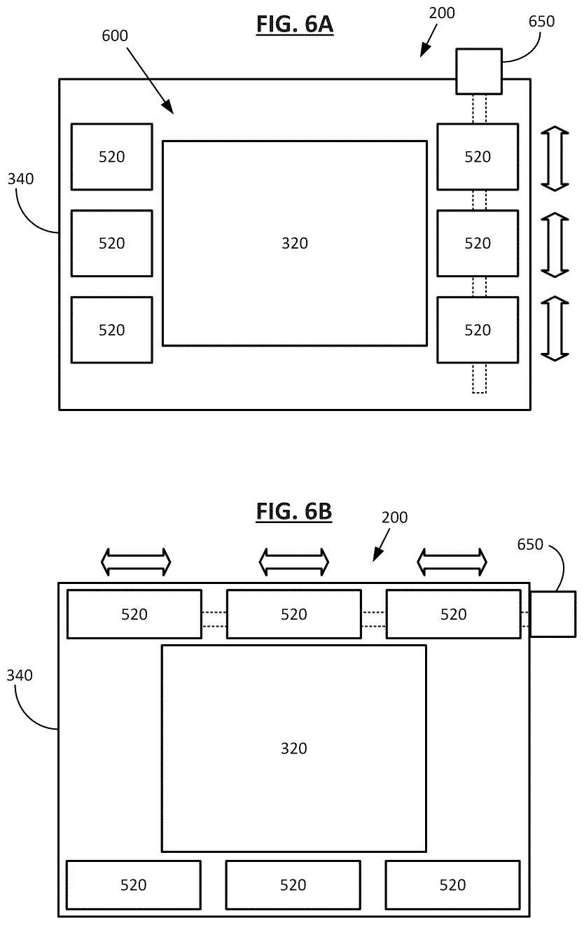

FIG. 5 shows an example of a fireplace system 200 in which a power source 110 may be one of a plurality of low-voltage components 500 that are connected to a plurality of ELV components 510 downstream. The low-volage components 500 may include the universal power supply that steps down the voltage from the power source 110 to ELV (less than 50 VAC or less than 120 VDC). The ELV components 510 may include, for example, fuse board 512 which may include one or more circuit boards or similar power distribution devices (including one or more resettable/non-fuse component or circuit breaker to provide overcurrent protection using any such appropriate means of breaking the circuit), relay board 514, controller/circuitry 516, a plurality of ELV heating elements 520, one or more LEDs 522, one or more speakers 524, and one or more displays 320, all of which operate at the ELV range while receiving power directly from the low-voltage power supply 110. Each of the ELV components 510 may operate at the ELV voltage or the ELV region (e.g., 12 VAC, 24 VAC, 36 VAC, or 48 VAC, and/or 20 VDC, 40 VDC, 60 VDC, 80 VDC, or 100 VDC, or any other suitable range or value therebetween). In some examples, the fireplace system 200 may include only ELV components 510, such that all electric components associated with or installed in the fireplace 200 operate at the ELV region, i.e., less than 50 VAC or 120 VDC.

In some examples, the system may include one or more heating control features such as devices that cause the heated air to be forced out (such as via a fan) or facilitate radiant heat, for example. In some examples, when using one or more heating elements that are less than 120 VAC such as 24 VAC, a transformer may be implemented, such that the transformer may change or adjust the voltage level for certain situations such as when the input voltage changes, such as between different countries or regions (e.g., North America has 120 VAC and Europe has 230 VAC for the power source). As such, in some examples, when a 120 VAC input is used, the transformer may transform the 120 VAC current to 24 VAC current, at which stage the heating element may use the 24 VAC current as power source.

In some examples, the low voltage components 500 may include an inlet module such as a 120/230V disconnect switch and components for overcurrent protection, as well as one or more filters such as power line filters to reduce the effects of electrical noise or power anomalies on the downstream components. In some examples, the universal power supply 120 may be a 1500 W power supply or any other suitable supply that is consistent on any power line voltage. In addition to operating as a step-down transformer and AC/DC converter, the universal power supply 120 may also provide isolation from the downstream components. The components may be selected or adjusted so as to meet any one or more of the safety standards or certifications as described above, as suitable.

The fuse board 512 may be operatively coupled with a power distribution board 511 or a power distribution device, which may provide power distribution to the downstream components as well as to provide overcurrent protection, overvoltage and monitoring. The distribution board 511 may provide isolation of the other components from the ELV heating elements 520 or the controller/circuitry 516. The controller/circuitry 516 may be any suitable circuitry such as a single-board computer or controller capable of providing electrical signals to other components such as the display monitor 320 and to provide general purpose input/output signals to control the LEDs 522 and the ELV heating elements 520. In some examples, the fireplace system 200 may be a fully digital fire system where all components of the fireplace system operate in the ELV range (thus, the fireplace system comprises entirely of ELV components 510) such that controllers using less power, such as a single-board computer (e.g., Raspberry Pi), a microcontroller board (e.g., Arduino), and/or any session border controller (SBC) may be implemented as the controller to control all components (e.g., all ELV components) of the fireplace system 200.

In addition, the controller/circuitry 516 may provide audio signals for the speakers 524, as well as wireless connectivity for the components that are wirelessly coupled thereto. The display monitor 320 may be any suitable type including but not limited to LED, OLED, LCD, IPS, and QLED monitors, showing for example flame visuals for the electric fireplace 200. The LEDs 522 may provide visual lighting, and the speakers 524 may provide audio feedback to enhance user experience. Although three (3) ELV heating elements 520 are shown, it is to be understood that any suitable number of ELV heating elements may be implemented. The controller/circuitry 516 may be capable of controlling operation of any one or more of the fuse board 512, relay board 514, ELV heating elements 520, LEDs 522, speakers, and/or the display monitors. In some examples, the display monitor may be replaced with LED matrix or matrices, projection, or any other suitable means or features of visual display. In some examples, the LEDs may be replaced with one or more lighting features such as individually addressable RGB LED lights.

FIGS. 6A through 6D show examples of an electric fireplace 200 with an array of ELV heating elements 520 implemented in different configurations on the housing 340 of the fireplace 200 as disclosed herein. The ELV heating elements 520 may be facing toward the user or facing outwardly from the surface in which they are implemented, and the ELV heating elements 520 may be disposed behind a protector to avoid the user directly touching or coming into contact with the heating elements 520. The ELV heating elements 520 may be operating in the same voltage (such as 12V) or at different voltages with respect to each other.

FIG. 6A shows a display 320 positioned in the center of a front portion 600 (or the user-facing portion) of the fireplace 200, and the array of ELV heating elements 520 is located in two columns surrounding the display 320 on the two opposing sides, with each column having multiple heating elements.

FIG. 6B shows a display 320 positioned in the center of the front portion 600 (or the user-facing portion) of the fireplace 200, and the array of ELV heating elements 520 is located in two rows surrounding the display 320 on the top portion and on the bottom portion, with each row having multiple heating elements.

FIG. 6C shows a display 320 positioned in the center of the front portion 600 (or the user-facing portion) of the fireplace 200, and the array of ELV heating elements 520 is located to surround the display 320 on all four sides, including the top portion, the bottom portion, and the side portions.

FIG. 6D shows the ELV heating elements 520 being positioned on multiple sides of the fireplace 200, including on any two or more of the front portion 600, top portion 630, side portions 620, and back portion 610. Implementing the ELV heating elements 520 on the front portion 600, top portion 630, side portions 620, and back portion 610 of the fireplace 200 enables a 360-degree heating or fire experience. In some examples, additional display monitors may be implemented on the top, side, and/or back portions as suitable or preferable for the user to enhance the experience.

In any of the above examples, one or more linear actuators 650 or linear motors that are ELV-compatible (e.g., operable using a voltage level that is in the extra-low-voltage range) may be implemented to actively adjust the position of the ELV heating elements 520 in the array of heating elements along any preferred direction (e.g., along the arrows shown in FIG. 6A), resulting in a dynamic heating experience for the users. In some examples, the one or more linear actuators 650 adjust positions of the ELV heating elements 520 in one or more directions with respect to each other or with respect to the housing of the fireplace, such as in the x-axis (vertical directional changes, e.g., as shown in FIG. 6A), in the y-axis (horizontal directional changes, e.g., as shown in FIG. 6B), in a combination of the x-axis and the y-axis (diagonal directional changes), and/or in the z-axis (in a direction protruding from a surface of the fireplace or receding into the fireplace), as suitable. With active control (or person tracking), heating elements and linear motors may be used to direct the heat generated by the ELV heating elements 520 to the people in the room, making a more realistic experience (e.g., resembling a wood fire, where the warm areas change over time). In some examples, one or more of the ELV heating elements 520 may include electrical resistance heating elements or self-regulating heating elements, such as positive-temperature-coefficient (PTC) heating elements, whose resistance increases with temperature. In some examples, one or more of the ELV heating elements 520 may include panel heating elements such as wall-mounted electric panel heating elements, such as those that use stack-convection heating elements that operate in the ELV range. Other ELV-compatible peripherals such as sensors, lights, displays, and actuators, may be implemented as well. In some examples, the fireplace may have at least one adjustable louver for the discharge of the heating element for directional changes in the x-axis (vertical directional changes), in the y-axis (horizontal directional changes), and/or in the combination of x-axis and y-axis (diagonal directional changes).

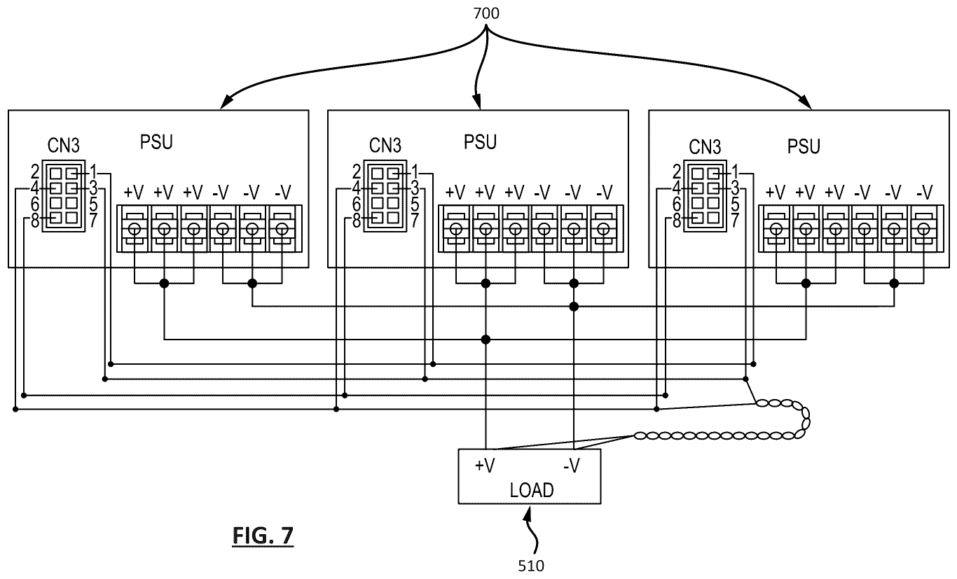

FIG. 7 shows an example of a plurality of individually operable power supply units (PSUs) 700 which may be provided and connected in a parallel configuration with one or more ELV components 510 in lieu of a single universal power supply, where the PSUs 700 may operate in parallel with each other. In some examples, the manufacturer of the fireplace may potentially retrofit existing units with additional heating capabilities by using the parallel configuration of the PSUs 700.

Beneficially, ELV components as disclosed herein may reduce the amount of electrical current that passes through human body when the body comes in contact with the ELV components. For instance, a dry human with a resistance of 100 kΩ would have the following current running through his or her body at the following voltages:
ELV (extra low voltage): 12 V/100 kΩ=0.12 mA
LV (low voltage): 240 V/100 kΩ=2.4 mA

Referring to the website “How Much Current Can The Human Body Withstand?” at https://www.scienceabc. com/humans/how-many-volts-amps-kill-you-human. html, accessed Sep. 23, 2025, a current of 1 mA causes a reaction of a faint tingle. A current of 5 mA may cause a reaction of a slight shock being felt, which may be disturbing but not painful. Most people can “let go” but strong involuntary movements can cause injuries. A current of 6-30 mA may cause a painful shock, which may cause loss of muscular control. This is the range where “freezing currents” start and may not be possible to “let go. ” A current of 50-150 mA may cause extreme pain, respiratory arrest, severe muscular contractions, and the individual cannot let go, increasing the risk of death. A current of 1-4.3 A may cause ventricular fibrillation, and muscular contraction and nerve damage may begin, with increased risk of death. A current of 10 A may cause cardiac arrest and severe burns, with probable risk of death.

The configuration of having ELV components downstream of the low-voltage components (such as the universal power supply) beneficially allows for any additional suitable ELV components to be integrated into the system without requiring the entire system to be rewired, and the controlling of additional ELV components can be performed using suitable industrial control panels as known in the art. The ELV heating elements may include those that are used in hybrid or electric vehicles.

The use of ELV components may also beneficially reduce the negative effects caused by varying line voltage on the heating element output. For example, when using a typical resistive heating element, the resistance remains the same as the voltage varies, creating an inconsistent heat.

The use of ELV components beneficially allows for a simpler and safer routing within the unit (or system) as the incoming voltage (e.g., 120V) would only be on the input to the power supply, which would be localized in the unit with, for example, Ingress Protection IP2x (which protects the components from touch by fingers and objects greater than 12 mm, according to EN IEC 60529 standards) or equivalent.

The embodiments of electric fireplace as disclosed herein are also safer and more accessible to troubleshoot for a repairing technicians working on the fireplace. ELV systems can be worked on while energized, whereas low-voltage systems typically require lock-out-tag-out (LOTO) or personal protective equipment (PPE). Ignoring such safety measures result in an unnecessary exposure to the risk of electrical shock. In a residential environment, diagnosis and repair of the fireplace as disclosed herein is possible without requiring the appliance to be disconnected (either unplugged or having a circuit breaker disengaged), thereby providing convenience for the residents to diagnose and repair their own product or to minimize disruptions while technicians perform their work on the fireplace.

The embodiments of electric fireplace as disclosed herein also support a sustainable and environmentally friendly product design. By enabling both consumers and professionals to repair the fireplace, the lifetime of the fireplace can be extended without requiring a totally new unit to be sent as replacement if the repair is complicated by a system with a more dangerous electrical system (that is, an electrical system with higher operating voltages than ELV). In the current embodiments, the manufacturers are also allowed to design and upgrade components as technical evolves or features are designed.

The embodiments of electric fireplace as disclosed herein may also enable a more accessible electrical system that could be upgraded as technology becomes accessible or consumer preferences for features evolve. An ELV-operated system also creates an opportunity to source components by utilizing existing supply chains (e.g. automotive or industrial) that are present in the locality where the product is assembled, thus not only benefitting the manufacturer with respect to cost, but also providing environmental benefits by reducing the length of the supply chain requiring less carbon emissions from overseas shipping or air freight. These benefits can also be passed along to the consumers; because the products can be sourced from vendors servicing large-scale, high-volume industries, these components would be less expensive to procure and less complex to manufacture or implement, therefore reducing the total manufacturing costs for the fireplaces. Accessing high-volume, high-quality suppliers situated in locales supports the overall corporate strategy to de-risk supply chains outside of volatile regions of the world while remaining competitive on pricing.

The embodiments of electric fireplace as disclosed herein may also align with the standards of multiple different regions, for example in North America, Europe, Asia, Africa, etc., without substantial modifications (or any modifications in some examples) to the existing hardware.

The ELV components, such as ELV heating elements, may be implemented in one or more different types of fireplaces, such as rotisserie fireplaces and digital fireplaces. Rotisserie fireplaces include outdoor fireplaces with one or more rotisserie rods placed above the heating surface of the fireplace such that meat may be cooked on the fireplace. Digital fireplaces include electric fireplaces with digital displays coupled thereto, such as LED monitors or LED lights and mirrors that are placed at a proximity of the electric fireplace. The LED monitors or lights may show flickering lights that imitate lights from actual fire, and the mirrors may reflect the light to create depth and movement. In some examples, the digital fireplace may incorporate a water vapor system that produces a realistic-looking smoke effect. In the rotisserie and digital fireplaces, a portion or an entirety of the heating elements implemented therein may be replaced with the ELV heating elements such that the rotisserie and digital fireplaces may operate with lower electric power requirement.

Numerous characteristics and advantages have been set forth in the preceding description, including various alternatives together with details of the structure and function of the devices and/or methods. Moreover, the scope of the various concepts addressed in this disclosure has been described both generically and with regard to specific examples. The disclosure is intended as illustrative only and as such is not intended to be exhaustive. It will be evident to those skilled in the art that various modifications may be made, especially in matters of structure, materials, elements, components, shape, size, and arrangement of parts including combinations within the principles of the disclosure, to the full extent indicated by the broad, general meaning of the terms in which the appended claims are expressed. To the extent that these various modifications do not depart from the spirit and scope of the appended claims, they are intended to be encompassed therein.

What is claimed is:

1. An electric fireplace comprising:
a plurality of extra-low-voltage (ELV) heating elements each operating at less than 50V of alternating current (VAC) or 120V of direct current (VDC) to generate heat for the electric fireplace; and
a universal power supply operatively coupled with the plurality of ELV heating elements, wherein the universal power supply operates to receive, convert, and step down an alternating current (AC) power source to provide power for the plurality of ELV heating elements.

2. The electric fireplace of claim 1, wherein the universal power supply is located in a low voltage region of the electric fireplace, and the ELV heating elements are located in an ELV region of the electric fireplace, wherein the ELV region defines at least 80% of a visible or tangible surface of the electric fireplace.

3. The electric fireplace of claim 1, wherein the universal power supply is located external to the ELV heating elements and is coupled to the ELV heating elements via an electrical connector.

4. The electric fireplace of claim 3, wherein the ELV heating elements are disposed in a high-risk location for electric shock, and the universal power supply is disposed in a low-risk location for electric shock.

5. The electric fireplace of claim 4, wherein the high-risk location and the low-risk location are in separate rooms of a building or in separate buildings from each other.

6. The electric fireplace of claim 1, further comprising at least one low-voltage component and a plurality of ELV components, wherein the universal power supply is one of the at least one low-voltage component, and the ELV components include the ELV heating elements that are located downstream of the at least one low-voltage component.

7. The electric fireplace of claim 6, the ELV components further comprising:
a power distribution device operative to distribute power to the ELV components downstream of the fuse board and to provide overcurrent protection using a means of breaking a circuit.

8. The electric fireplace of claim 6, the ELV components further comprising:
a relay board operative to provide isolation of other ELV components from the ELV heating elements.

9. The electric fireplace of claim 6, the ELV components further comprising:
one or more heating control features;
one or more speakers;
one or more visual fire features;
one or more lighting features; and
a controller configured to control operation of the heating control features, the speakers, the visual fire features, the lighting features, and the ELV heating elements.

10. The electric fireplace of claim 1, further comprising a plurality of additional ELV components such that all electric components of the electric fireplace operate at less than 50VAC or 120VDC.

11. The electric fireplace of claim 1, wherein the ELV heating elements are disposed in two columns on the at least one portion of the electric fireplace.

12. The electric fireplace of claim 1, wherein the ELV heating elements are disposed in two rows on the at least one portion of the electric fireplace.

13. The electric fireplace of claim 1, further comprising a display monitor disposed on the at least one portion of the electric fireplace, wherein the ELV heating elements are disposed to surround the display monitor on all four sides.

14. The electric fireplace of claim 1, wherein the at least one portion of the electric fireplace includes two or more of: a front portion, a top portion, at least one of two side portions, or a back portion of the electric fireplace.

15. The electric fireplace of claim 1, further comprising at least one adjustable louver for the discharge of the heating element for directional changes along an x-axis, an y-axis, or a combination thereof.

16. The electric fireplace of claim 1, wherein the universal power supply comprises a plurality of individually operable power supply units connected in a parallel configuration.

17. The electric fireplace of claim 1, wherein the universal power supply includes one or more batteries.

18. An electric fireplace comprising:
a housing comprising one or more linear actuators;
a plurality of extra-low-voltage (ELV) heating elements each operating at less than 50V of alternating current (VAC) or 120V of direct current (VDC) to generate heat for the electric fireplace; and
a universal power supply operatively coupled with the plurality of ELV heating elements, wherein the universal power supply operates to receive, convert, and step down an alternating current (AC) power source to provide power for the plurality of ELV heating elements;
wherein the linear actuators are configured to adjust positions of the ELV heating elements in one or more directions with respect to the housing.

19. The electric fireplace of claim 18, wherein the one or more directions includes one or more of: a direction along an x-axis, a direction along a y-axis, a combination of the x-axis and the y-axis, or a z-axis.

20. The electric fireplace of claim 18, wherein the one or more linear actuators are ELV-compatible.
